(19) United States
(12) Patent Application Publication
(10) Pub. No.: US 2024/0419960 A1
(43) Pub. Date: Dec. 19, 2024

(54) BACKPROPAGATION FOR DISCRETE VARIABLES

(71) Applicant: Microsoft Technology Licensing, LLC, Redmond, WA (US)

(72) Inventors: Liyuan LIU, Redmond, WA (US); Chengyu DONG, San Diego, CA (US); Xiaodong LIU, Woodinville, WA (US); Bin YU, Berkeley, CA (US); Jianfeng GAO, Woodinville, WA (US)

(21) Appl. No.: 18/211,488

(22) Filed: Jun. 19, 2023

(51) Int. Cl. G06N 3/08

(52) U.S. Cl. CPC G06N 3/08

(57) ABSTRACT

Generally discussed herein are devices, systems, and methods for backpropagation of a discrete latent variable. A method can include determining, to a second-order accuracy, an approximation of a gradient of a parameter of a discrete latent variable of a neural network (NN), adjusting the parameter based on the approximation of the gradient resulting in an adjusted parameter, and operating the NN using the adjusted parameter

### BACKGROUND

Accurate backpropagation, the cornerstone of deep learning, was previously limited to computing gradients solely for continuous variables.

### SUMMARY

A method, device, or a machine-readable medium for backpropagation of a discrete latent variable are provided. A method can include determining, to a second-order accuracy, an approximation of a gradient of a parameter of a discrete latent variable of a neural network (NN). The method can include adjusting the parameter based on the approximation of the gradient resulting in an adjusted parameter. The method can include operating the NN using the adjusted parameter.

Determining the approximation of the gradient can include sampling a one hot encoding of output of the NN resulting in a sample. Determining the approximation of the gradient can include computing a first combination of the sample and a tempered probability distribution of outcomes for the output of the NN. Determining the approximation of the gradient can include determining a second probability distribution of outcomes based on the tempered probability distribution and the output of the NN. Determining the approximation of the gradient can include computing a second combination of the probability distribution of outcomes and the second probability distribution of outcomes resulting in a third probability distribution of outcomes. Determining the approximation of the gradient can include altering a value of the sample based on the third probability distribution of outcomes resulting in an altered value. Adjusting the parameter can be based on the altered value.

Determining the approximation of the gradient can include determining a first probability distribution of outcomes based on output of the NN. Determining the approximation of the gradient can include determining, based on the first probability distribution of outcomes, a one hot encoding. The first combination can be an average. The second combination is a weighted difference between the probability distribution of outcomes and the second probability distribution of outcomes.

A temperature of the tempered probability distribution can be greater than, or equal to, one. The operations of the method can be constrained to a baseline subtraction that is set to an expected value of the sample. Determining the approximation of the gradient can be performed without determining a Hessian matrix or a second-order derivative.

A device, machine-readable medium, or system can be configured to implement the method.

### BRIEF DESCRIPTION OF DRAWINGS

FIG. 1 is a block diagram of an example of an environment including a system for neural network (NN) training.

FIG. 2 illustrates, by way of example, a diagram of an embodiment of a method for backpropagation in an NN with a discrete latent variable.

FIG. 3 illustrates, by way of example, loss versus number of training epochs for a variety of p values.

FIG. 4 illustrates, by way of example, a heatmap of training ELBO on MNIST-VAE for a variety of temperatures and categorical and latent dimension.

FIG. 5 illustrates, by way of example, heatmaps of performance of six methods under different batch sizes and latent dimensions.

FIG. 6 illustrates, by way of example, graphs of loss and accuracy on a valid set for the unsupervised parsing on ListOps.

FIG. 7 illustrates, by way of example, a bar graph of negative ELBO for some subtraction baselines and a variety of latent and categorical dimensions.

FIG. 8 illustrates, by way of example, a block diagram of an embodiment of a method for backpropagation to a discrete latent variable.

FIG. 9 illustrates, by way of example, a block diagram of an embodiment of a machine (e.g., a computer system) to implement one or more embodiments. The machine 900 can implement ReinMax.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Artificial intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications.

Many NNs are represented as matrices of weights (sometimes called parameters) that correspond to the modeled connections. NNs operate by accepting data into a set of input neurons that often have one or more outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another downstream neuron-if the threshold is not exceeded then, generally, the value is not transmitted to a downstream neuron and the synaptic connection remains inactive. The process of weighting and testing continues until an output neuron is reached; the pattern and values of the output neurons constituting the result of the NN processing. The weights of the NNs are usually in the continuous domain, but can be values in the discrete domain.

The optimal operation of most NNs relies on accurate weights. However, NN designers do not generally know which weights will work for a given application. Also, determining weights for discrete weight values is difficult with modern gradient computations. NN designers typically choose a number of layers which may include a number of neurons, pooling, sampling operations, memory units (e.g., long-short term memory (LSTM), gated recurrent unit (GRU), or the like and specific connections between layers including circular connections. A training process may be used to determine appropriate weights. An initial selection of weight values is performed. The initial weights are iteratively improved via backpropagation or other algorithms established in the art.

In some examples, initial weights may be randomly selected. Training data is fed into the NN and results are compared to an objective function that provides an indication of error. The error indication is a measure of how wrong the result of the NN is compared to an expected result. This error is then used to correct the weights. Over many iterations, the weights will collectively converge to encode an approximation of the function from the operational data to a range of values specific to the learning task into the NN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used.

Backpropagation, as previously discussed, operates accurately on continuous variables. However, not all variables are continuous, many are discrete. Current backpropagation techniques are not very accurate for discrete variables.

Inaccurate backpropagation for discrete variables hinders various applications involving discrete latent variables. To address the inaccurate backpropagation, embodiments provide a novel approach for approximating the gradient of parameters involved in generating discrete latent variables. A widely used heuristic on discrete variables called Straight-Through (ST) works as a first-order approximation of the gradient for the discrete variables. Embodiments include a novel method called “ReinMax”, which is a second-order numerical method for solving ordinary differential equations (ODEs), to approximate the gradient. ReinMax achieves second-order accuracy without requiring Hessian or other second-order derivatives. Experiments on structured output prediction and unsupervised generative modeling tasks show improvement over the prior techniques. The experiments show that ReinMax brings consistent improvements over the state of the art, including ST and Straight-Through Gumbel-Softmax (STGS).

There has been a persistent pursuit to build NN models with discrete or sparse variables. Correspondingly, many attempts have been made to develop effective and efficient algorithms to approximate the gradient for parameters that are used to generate discrete variables, and most existing algorithms rely on Straight-Through (ST) to bridge discrete variables and backpropagation. The development of ST was based on the simple intuition that non-differentiable functions (e.g., sampling of discrete latent variables) can be approximated with an identity function in the backpropagation. Due to the lack of theoretical underpinnings, there is neither guarantee that ST can be viewed as an approximation of the gradient, nor is there guidance on hyper-parameter configurations. Thus, developers search different ST settings for different applications in a trial-and-error manner, which is laborious and time-consuming.

ST was shown to operate as a special case of the forward Euler method that approximates the gradient with first-order accuracy. This provided guidance on how to optimize hyper-parameters of ST and its variants. The algorithm ST prefers to set the temperature τ≥1, and Straight-Through Gumbel-Softmax prefers to set τ≤1.

Embodiments improve ST with a novel gradient estimation method called “ReinMax”. ReinMax achieves second-order accuracy. Second-order accuracy means that the approximation of embodiments matches a Taylor expansion of the gradient to the second order, without requiring the Hessian matrix or other second-order derivatives. Results of experiments on unsupervised generative modeling and structured output prediction are provided and help show that ReinMax brings consistent improvements over state of the art.

Embodiments provide a novel perspective that reveals ST as a first-order approximation to the gradient. Embodiments provide a novel and sound gradient estimation method (i.e., ReinMax), which achieves second-order accuracy without requiring the Hessian matrix or other second-order derivatives.

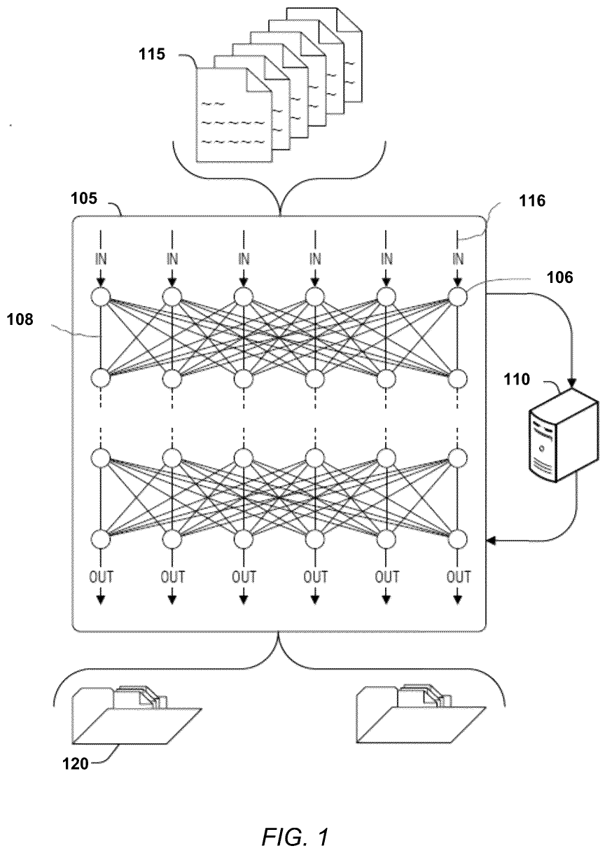

FIG. 1 is a block diagram of an example of an environment including a system for NN training. The system includes an NN 105 that is trained using a processing node 110. The processing node 110 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the NN 105, or even different nodes 107 within layers. Thus, a set of processing nodes 110 is arranged to perform the training of the ANN 105.

The set of processing nodes 110 is arranged to receive a training set 115 for the NN 105. The NN 105 comprises a set of nodes 107 arranged in layers (illustrated as rows of nodes 107) and a set of inter-node weights 108 (e.g., parameters) between nodes in the set of nodes. In an example, the training set 115 is a subset of a complete training set. Here, the subset may enable processing nodes with limited storage resources to participate in training the NN 105.

The training data may include multiple numerical values representative of a domain, such as a word, symbol, other part of speech, or the like. Each value of the training or input 117 to be classified after NN 105 is trained, is provided to a corresponding node 107 in the first layer or input layer of NN 105. The values propagate through the layers and are changed by the objective function.

As noted, the set of processing nodes is arranged to train the NN to create a trained NN. After the NN is trained, data input into the NN will produce valid classifications 120 (e.g., the input data 117 will be assigned into categories), for example. The training performed by the set of processing nodes 107 is iterative. In an example, each iteration of the training the NN 105 is performed independently between layers of the NN 105. Thus, two distinct layers may be processed in parallel by different members of the set of processing nodes. In an example, different layers of the NN 105 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 107 (e.g., neurons) are trained independently. In an example, the nodes are trained on different hardware. The training of the NN 105 can include backpropagation that includes ReinMax.

The idea of incorporating discrete latent variables and NNs dates back to sigmoid belief network and Helmholtz machines. Consider a tempered softmax as softmax_{τ}(θ)ᵢ=exp(θᵢ/τ)/Σⱼ₌₁ⁿ exp (θⱼ/τ), where n is the number of possible outcomes, θ∈ [symbol] ^{n×1} is the parameter, and τ is the temperature. For i∈[1, . . . , n] consider a one-hot representation as Iᵢ∈ [symbol] ^{n×1}, whose element equal 1 if it is the i-th element or equals 0 otherwise. Let D be a discrete random variable and D∈{I₁, . . . , Iₙ}, assume the distribution of D is parameterized as: p(D=Iᵢ)=πᵢ=softmax(θ)ᵢ, and mark softmax_{τ}(θ) as π^{(τ)}. Given a continuously differentiable function ƒ: [symbol] ^{n×1}→ [symbol] , an aim is to minimize as follows (note that temperature scaling is not used in the generation of D):

$${min}_{θ} ℒ ( θ ) = {E}_{D ∼ softmax ( θ )} [ f ( D ) ]$$

The gradient of θ is determined as ∇:

$$∇ := \partial ℒ ( θ ) / \partial θ = {\sum }_{i} f ( {I}_{i} ) d {π}_{i} / d θ$$

In many applications it is usually too costly to compute ∇, as it involves an iteration through {I₁, . . . , Iₙ} and evaluating ƒ is costly. Correspondingly, many efforts have been made to estimate ∇ efficiently.

Examples of attempts to estimate the gradient of discrete variables include REINFORCE, ST, and STGS. REINFORCE is unbiased (i.e., the expected value of the gradient is value the gradient) and only requires the distribution of the discrete variable to be differentiable (i.e., no backpropagation through ƒ). Despite the REINFORCE estimator being unbiased, it tends to have prohibitively high variance, especially for networks that have other sources of randomness (i.e., dropout or other independent random variables). Recently, attempts have been made to reduce the variance of REINFORCE. Still, it has been found that the REINFORCE style estimators fail to work well in many real-world applications. For example, through experimental results provided elsewhere, one can observe that although the REINFORCE has the potential to achieve the optimal loss, it demands a huge batch size and thus an overwhelming computation workload. Also, empirical comparisons with two recent REINFORCE-style estimators that are equipped with variance reduction techniques it is observed that they achieve an inferior performance compared with estimators like ST and STGS.

In practice, a popular family of estimators are ST estimators. ST estimator compute the backpropagation “through” a surrogate that treats the non-differentiable function (e.g., the sampling of D) as an identity function. The idea of ST originates from the perceptron algorithm that leverages a modified chain rule and utilizes the identity function as the proxy of the original derivative of a binary output function. Others have improved this method by incorporating nonlinear functions like sigmoid or softmax, and further incorporate the Gumbel parameterization with this technology. ST and STGS are now described.

As detailed in the pseudocode in Algorithm 1, the ST estimator treats the sampling process of D as an identity function during the backpropagation.

Algorithm 1: ST

Input θ: softmax input, τ: temperature
Output: D: one-hot samples.
π₀ ← softmax(θ)
D ← sample_one_hot(π₀)
π₁ ← softmax_{τ}(θ)
/* stop_gradient(·) duplicates its input and detaches it from backpropagation.*/
/* stop_gradient(·) detaches its input from the computation graph and ignores it during the
backpropagation. */
D ← π₁ − stop_gradient(π₁) + D
return D

$${\overbrace{∇}}_{ST} := \partial f ( D ) / \partial D \cdot d π / d θ$$

In practice \hat{∇}_{ST} is usually implemented with the tempered softmax, under the hope that the temperature hyper-parameter t may be able to reduce the bias introduced by \hat{∇}_{ST}. The STGS estimator is built upon on the Gumbel re-parameterization trick. It is observed that the sampling of D can be reparameterized using Gumbel random variables at the zero-temperature limit of the tempered softmax:

$$D = {lim}_{τ \to 0} {softmax}_{τ} ( θ + G )$$

Where Gᵢ are independent and identically distributed and Gᵢ˜Gumbel (0,1).

STGS treats the zero-temperature limit as an identity function during the backpropagation:

$${\overbrace{∇}}_{STGS} := \partial f ( D ) / \partial D \cdot {d softmax}_{τ} ( θ + G ) / d θ$$

Both \hat{∇}_{ST} and \hat{∇}_{STGS} are clearly biased. However, since the mechanism of ST is unclear, it remains unanswered what the form of their biases are, how to configure their hyper-parameters for optimal performance, or even whether E[\hat{∇}_{ST}] or E[\hat{∇}_{STGS}] can be viewed as an approximation of ∇. Thus, what follows is an analysis of how \hat{∇}_{ST} approximates ∇ and how it can be improved.

In numerical analyses, extensive studies have been conducted to develop numerical methods for solving ordinary differential equations. In this study, we leverage these methods to approximate ∇ with the gradient of ƒ. To begin, it is demonstrated that ST works as a first-order approximation of ∇. Then, ReinMax is presented in more detail. ReinMax provides a more accurate gradient approximation and achieves second-order accuracy.

Assume a first-order approximation of ∇ is estimated as \hat{∇}_{1st-order}.

$$One such {\overbrace{∇}}_{1 st - order} := {\sum }_{i} \frac{{\sum }_{j} {π}_{j} \partial f ( {I}_{j} )}{\partial {I}_{j}} ( {I}_{i} - {I}_{j} ) d {π}_{i} / d θ .$$

To understand why \hat{∇}_{1st-order} is a first-order approximation, rewrite ∇ as Equation 1:

$$∇ = {\sum }_{i} \frac{( f ( {I}_{i} ) - E [ f ( D ) ] ) d {π}_{i}}{d θ} + {\sum }_{i} \frac{( E [ f ( D ) ] ) d {π}_{i}}{d θ} = {\sum }_{i} {\sum }_{j} {π}_{j} ( f ( {I}_{i} ) - f ( {I}_{j} ) ) d {π}_{i} / d θ$$

Then comparing \hat{∇}_{1st-order} and the rewritten ∇, it can be seen that \hat{∇}_{1st-order} approximates

$$f ( {I}_{i} ) - f ( {I}_{j} ) as \frac{\partial f ( {I}_{j} )}{\partial {I}_{j}} ( {I}_{i} - {I}_{j} ) .$$

In numerical analyses, this approximation is known as the forward Euler method, which has first-order accuracy. Thus, it is known that \hat{∇}_{1st-order} is a first-order approximation of ∇.

Note that it can be shown that \hat{∇}_{ST} is also a first-order approximation. Note this may not apply to some variants of ST. As ST uses only a first-order approximation for ƒ(Iᵢ)−ƒ(Iⱼ), the gradient can be improved by determining a higher-order approximation for the gradient.

Higher-order accuracy in embodiments can be determined without computing higher-order derivatives. Embodiments can use a second-order approximation to reduce bias of the gradient estimator and provide an improved gradient. The second-order approximation can approximate

$$f ( {I}_{i} ) - f ( {I}_{j} ) as 1 / 2 ( \frac{\partial f ( {I}_{i} )}{\partial {I}_{i}} + \frac{\partial f ( {I}_{j} )}{\partial {I}_{j}} ( {I}_{i} - {I}_{j} ) .$$

This approximation has second-order accuracy and is a second-order approximation of the gradient.

Based on the second order approximation, embodiments use ReinMax in training with discrete variables. The technique of training with the second order approximation is described in pseudocode in Algorithm 2:

Algorithm 2: ReinMax

Input θ: softmax input, τ: temperature
Output: D: one-hot samples.
π₀ ← softmax(θ)
D ← sample_one_hot(π₀)
π₁ ← (D + softmax_{τ}(θ))/2
π₁ ← softmax(stop_gradient(ln(π₁) − θ) + θ)
π₂ ← 2 · π₁ − 1/2 · π₀
D ← π₂ − stop_gradient(π₂) + D
return D

D is then used as the input of other deep learning models. For example, in MNIST-VAE, the encoder model outputs several distributions of discrete variables, ReinMax samples discrete variables (D) from these distributions, and the decoder takes D as the input and attempts to reconstruct the input of the encoder. As another example, in unsupervised parsing, the model generates several distributions of the parsing tree, and ReinMax samples discrete tree out of these distributions, and so on.

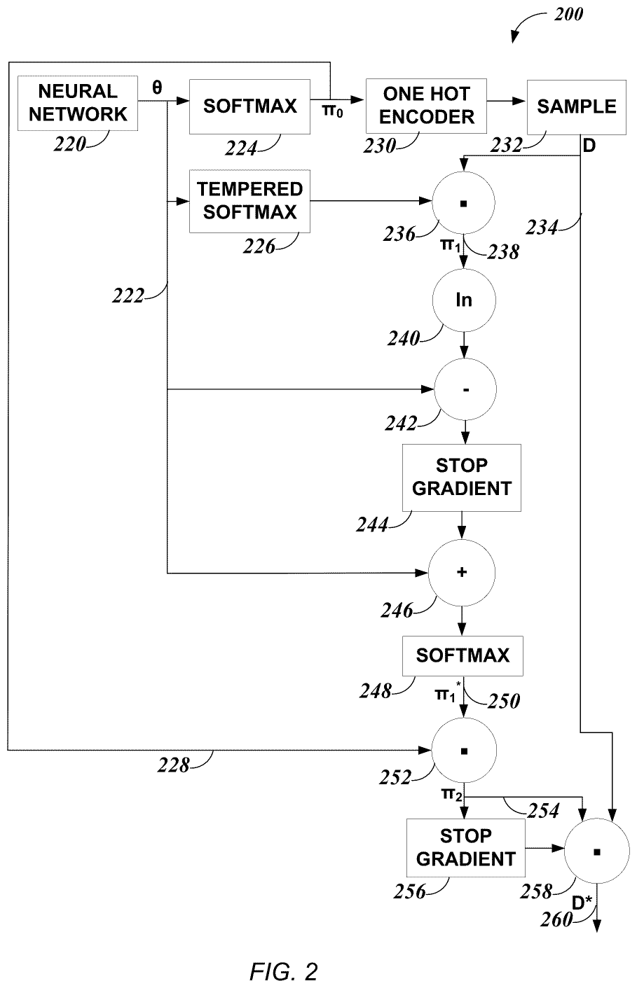

FIG. 2 illustrates, by way of example, a diagram of an embodiment of a method 200 for backpropagation in an NN with a discrete latent variable. An NN 220 produces an output 222. The output 222 is provided as input to a softmax function 224, a tempered softmax function 226, a subtractor 242, and an adder 246. The softmax function 224 converts the output 222 to a probability distribution of outcomes 228. The tempered softmax function 226 is similar to the softmax function 224, but operates based on a user configurable temperature.

A one hot encoder 230 converts the probability distribution of outcomes from the softmax function 224 into a vector with a single one valued entry and the remaining entries are zeros. The single one-valued entry is the one corresponding to the highest probability. The vector from the one hot encoder is sampled by sampler 232. The sample is represented by D 234.

The output of the tempered softmax 226 and D 234 are provided as input to an algorithmic operator 236. The operator 236 determines an output 238 that is the average of the output of the tempered softmax 226 and D 234. An operator 240 determines a natural log of the output 238. A subtractor 242 determines a difference between an output of operator 240 and the output 222. A stop gradient 244 is applied to the output of the subtractor 242.

An adder 246 adds the result of the stop gradient 244 to the output 222. Another softmax function 248 is applied to the output of the adder 246 resulting in a second probability distribution of outcomes 250. An operator 252 determines a weighted difference 254 between the second probability distribution of outcomes 250 and the probability distribution of outcomes 228. The weights applied by the operator 252 can be one half for the weighted distribution of outcomes 228 and two for the second weighted distribution of outcomes 250.

Another stop gradient 256 can be applied to the weighted difference 254. A result of the stop gradient 256, the weighted difference 254, and D 234 can be combined by operator 258 resulting in a new value for D 260. The new value for D 260 is the value of after backpropagation by the method 200. The operator 258 can add the weighted difference 254 and D 234 and subtract the result of the stop gradient 256 therefrom.

The computation overhead of the method 200 (“\hat{∇}_{ReinMax}”) is negligible yet it improves accuracy over prior techniques. The second-order accuracy provided by ReinMax is achieved by determining two first order derivatives and a product. ReinMax can be easily integrated with existing differentiation toolkits like PyTorch, for example.

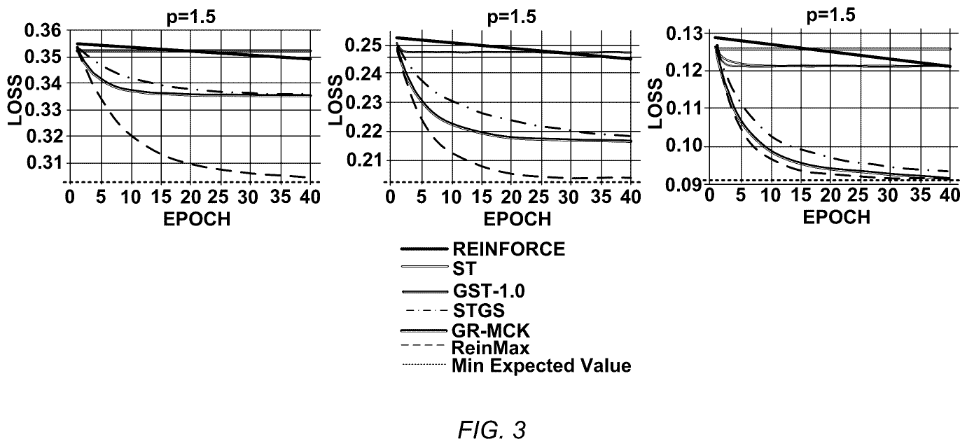

FIG. 3 illustrates, by way of example, loss versus number of training epochs for a variety of p values. As can be seen, ReinMax outperforms all of the other benchmarks in terms of convergence speed and overall loss for all p values used.

In some embodiments, E[ƒ(D)] can be chosen as a baseline for subtraction. Note that baseline subtraction is understood relative to Equation 1 where E[ƒ(D)] is subtracted from ƒ(Iᵢ). Note that other baseline subtractions are possible and result in different gradient approximations. The baseline E[ƒ(D)] outperforms other baselines as discussed below.

Tailoring temperature scaling, a technique widely used in gradient estimators, can be applied to ReinMax. A typical practice for applying temperature scaling for STGS is to set the temperature τ to a small value. ReinMax can benefit from a different technique of temperature scaling.

Before exploring the impact of temperature scaling on ReinMax, its role in STGS is revisited. As discussed, given

$$D = {lim}_{τ \to 0} {softmax}_{τ} ( θ + G ) ,$$

the Gumbel re-parameterization trick proposes to replace the categorical variable D with softmax_{τ}(θ+G) at a finite temperature. With this approximation, the Gumbel softmax estimator computes the gradient as E[∂ƒ(softmax_{τ}(θ+G))/∂softmax_{τ}(θ+G)·∂ƒ(softmax_{τ}(θ+G))/∂θ. Comparing this form with \hat{∇}_{STGS}, one observes that \hat{∇}_{STGS} further approximates ∂ƒ(softmax_{τ}(θ+G))/∂softmax_{τ}(θ+G) as ƒ(D)/∂D.

In summary, \hat{∇}_{STGS} conducts a two-step approximation: (1) it approximates

$${min}_{θ} E [ f ( D ) ] as {min}_{θ} E [ f ( {softmax}_{τ} ( θ + G ) ) ] ;$$

and (2) it approximates ∂ƒ(softmax_{τ}(θ+G))/∂softmax_{τ}(θ+G) as ƒ(D)/∂D. Since the bias introduced in both steps can be controlled by τ, it is preferred to set τ to a relatively small value (less than one) in determining \hat{∇}_{STGS}.

Temperature scaling in ReinMax can be used to smooth a gradient approximation as (π_{τ}=softmax_{τ}(θ)):

$${\overbrace{∇}}_{ReinMax} = 2 \cdot \frac{\overbrace{∇} ( {π}_{τ} + D )}{2} - \frac{1}{2 {\overbrace{∇}}_{ST}} .$$

In this way temperature scaling in \hat{∇}_{ReinMax} is used to stabilize the gradient approximation at the cost of accuracy instead of reducing bias. Thus, the value of t should be greater than, or equal to, one.

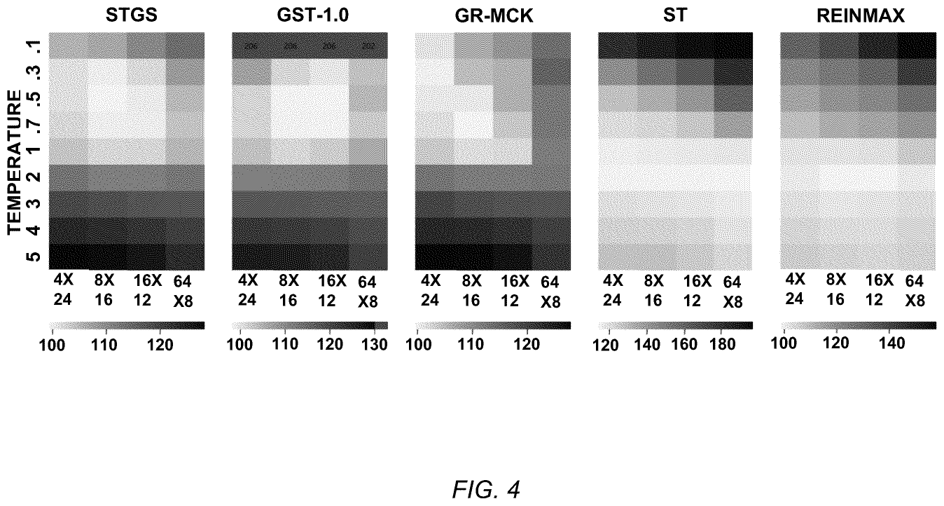

FIG. 4 illustrates, by way of example, a heatmap of training ELBO on MNIST-VAE for a variety of temperatures and categorical and latent dimension. In the heat map of FIG. 4 a lighter color indicates a higher accuracy. As is seen, ReinMax operates more accurately with temperatures greater than one, with top measurement realized at a temperature of about 2.

Embodiments are verified with empirical experiments using polynomial programming, unsupervised generative modeling, and structured output prediction. In all experiments, four baselines were compared to embodiments to determine the improvements provided by embodiments. The four baselines are ST, STGS, Gumbel-Rao Monte Carlo (GR-MCK), and Gapped ST (GST-1.0).

Polynomial programming experiments are discussed, followed by unsupervised generative modeling, and then structured output prediction is discussed. Following previous studies consider a simple and classic problem. Consider L independent identically distributed (i.i.d.) latent binary variables X₁, . . . , X_{L}∈{0,1} and a constant vector c∈ [symbol] ^{L×1}, and parameterize the distributions softmax of {X₁, . . . , X_{L}} with L functions, e.g., Xᵢ˜^{i.i.d.} Multinomial(softmax(θᵢ)). Set every dimension of c as 0:45, i.e., ∇i, cᵢ=0.45, and use

$${min}_{θ} {E}_{X} [ \frac{{‖ X - c ‖}_{p}^{p}}{L} ]$$

as the objective.

Considering a training curve with various p, first set the number of latent variables (i.e., L) as 128 and batch size as 256. The training curve is visualized in FIG. 3 for p=1.5, 2, and 3. In all cases, ReinMax achieved near optimal performance and the fastest convergence speed. Meanwhile, observe that ST and GST-1.0 do not perform well in all three cases. The final performance of STGS and GR-MCK is close to ReinMax, while ReinMax still has a faster convergence speed. As a summary, ReinMax obtains faster and more stable convergence.

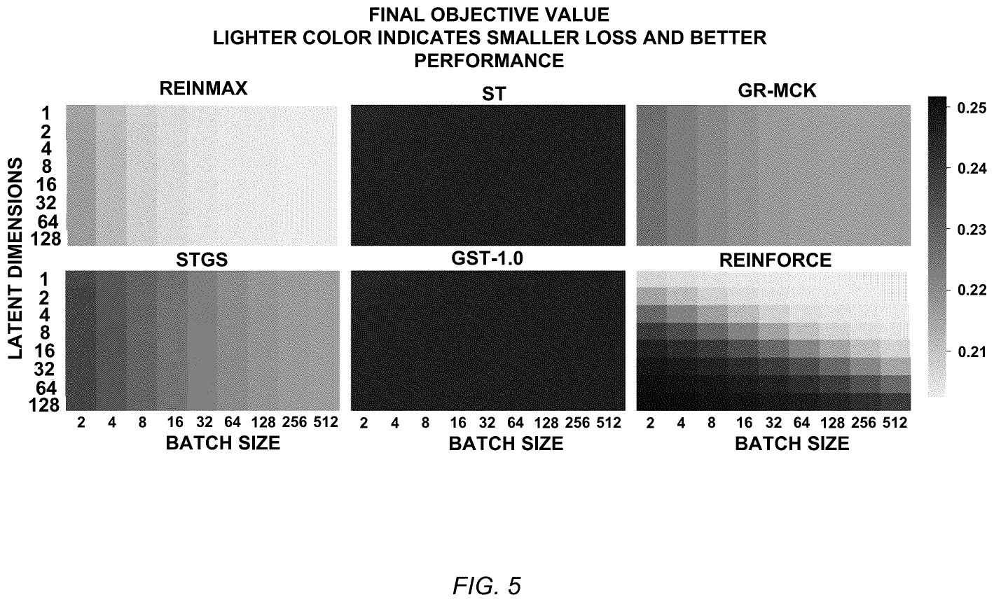

FIG. 5 illustrates, by way of example, heatmaps of performance of six methods under different batch sizes and latent dimensions. The results for p=2 are shown in FIG. 5. For REINFORCE, observe that although it has the potential to achieve the optimal performance for a small latent space, it requires a large batch size for large latent spaces (i.e., latent space has more than 16 different outcomes), which is consistent with the common wisdom that REINFORCE has a prohibitively high variance thus requiring a huge batch size. For all other methods, observe that they are less sensitive to latent dimension, which verifies an intuition to leverage ∂ƒ(x)/∂x to approximate the gradient. Comparing all methods over all cases, ReinMax achieves superior performance.

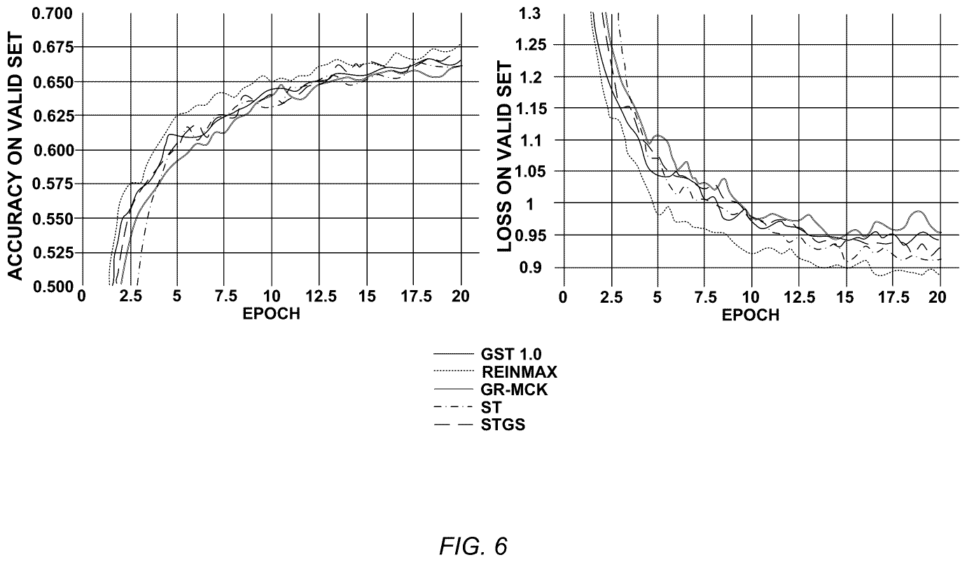

FIG. 6 illustrates, by way of example, graphs of loss and accuracy on a valid set for the unsupervised parsing on ListOps. Unsupervised parsing on ListOps was performed and results are summarized, including the average accuracy and the standard derivation, in Table 1. Although the ST algorithm performs poorly on polynomial programming, it achieves a reasonable performance on this task. Also, while all baseline methods perform similarly, ReinMax stands out and brings consistent improvements. This further demonstrates them benefits of achieving second-order accuracy and the effectiveness of our proposed method.

TABLE 1
Accuracy on ListOps

| | STGS | GR-MCK | GST-1.0 | ST | REINMAX |
|---|---|---|---|---|---|
| Accuracy | 66.87 ± | 66.48 ± | 66.19 ± | 66.48 ± | 67.64 ± |
| | 2.98 | 0.58 | 0.50 | 0.72 | 1.22 |

Now, the performance of training variational auto-encoders (VAE) with categorical latent variables on MNIST is benchmarked. Optimization performance for this unsupervised task is analyzed and it is shown that training performance on ELBO largely mirrors test performance.

Experiments on MNIST-VAE with only 4 latent dimensions and 8 categorical dimensions were conducted. Since the size of the latent space is only 4096, one can iterate through an entire latent space and compute a gradient, which allows one to evaluate the bias of gradient approximations directly. Specifically, the cosine similarity between the gradient of latent variables and its approximation given by various methods was measured. ReinMax achieves consistently more accurate gradient approximation across the training and, accordingly, faster convergence. Also, besides faster convergence, the performance of ReinMax is more stable.

Consider a larger latent space (i.e., 248). Specifically, consider 8 latent dimensions with 64 categorical dimensions, 16 latent dimensions with 12 categorical dimensions, 8 latent dimensions with 16 categorical dimensions, and 4 latent dimensions with 24 categorical dimensions. Also consider experiments with 10 latent dimensions and 30 categorical dimensions, that is the size of the latent space is 10³⁰.

TABLE 2
Training ELBO on MNIST (N × M refers to
N categorical dimensions and M latent dimensions)

| | AVG | 8 × 4 | 4 × 24 | 8 × 16 | 16 × 12 | 64 × 8 | 10 × 30 |
|---|---|---|---|---|---|---|---|
| STGS | 105.2 | 126.85 ± | 101.32 ± | 99.32 ± | 100.09 ± | 104.00 ± | 99.63 ± |
| | | 0.85 | 0.43 | 0.33 | 0.32 | 0.41 | 0.63 |
| GR- | 107.06 | 125.94 ± | 99.96 ± | 99.58 ± | 102.54 ± | 112.34 ± | 102.02 ± |
| MCK | | 0.71 | 0.25 | 0.31 | 0.48 | 0.48 | 0.18 |
| GST-1.0 | 104.25 | 126.35 ± | 101.49 ± | 98.29 ± | 98.12 ± | 102.53 ± | 98.64 ± |
| | | 1.24 | 0.44 | 0.66 | 0.57 | 0.57 | 0.33 |
| ST | 116.72 | 135.53 ± | 112.03 ± | 112.94 ± | 113.31 ± | 113.90 ± | 112.63 ± |
| | | 0.31 | 0.03 | 0.32 | 0.43 | 0.28 | 0.34 |
| ReinMax | 103.21 | 124.66 ± | 99.77 ± | 97.70 ± | 98.06 ± | 100.71 ± | 98.37 ± |
| | | 0.88 | 0.45 | 0.39 | 0.53 | 0.70 | 0.44 |

As summarized in Table 2, ReinMax achieves the highest performance on all configurations. For other methods, although GST-1.0 does not perform well on polynomial programming, it achieves strong performance on this task (MNIST-VAE). Also, although GR-MCK performs well on smaller categorical dimensions, its performance degenerates on larger ones like 64.

Experiments were conducted with a larger batch size (i.e., 200), longer training (i.e., 5×10⁵ steps), 32 latent dimensions, and 64 categorical dimensions. As shown in Table 3, ReinMax outperforms all baselines, including two REINFORCE-based methods.

TABLE 3
Training ELBO on MNIST.

| | | DisARM- | | | | | |
|---|---|---|---|---|---|---|---|
| | RLOO | Tree | STGS | GR-MCK | GST-1.0 | ST | ReinMax |
| Neg. | 104.03 ± | 103.10 ± | 97.32 ± | 110.74 ± | 96.09 ± | 116 ± | 93.44 ± |
| ELBO | 0.23 | 0.25 | 0.20 | 1.23 | 0.25 | 0.09 | 0.51 |

Despite GST-1.0 achieving good performance on most settings of MNIST-VAE, GST-1.0 fails to maintain this performance on polynomial programming and unsupervised parsing, as discussed before. This observation verifies our intuition that, due to the lack of understanding of the mechanism of ST, different applications have different preferences on its configurations. At the same time, ReinMax achieves consistent performance over all baselines in all settings.

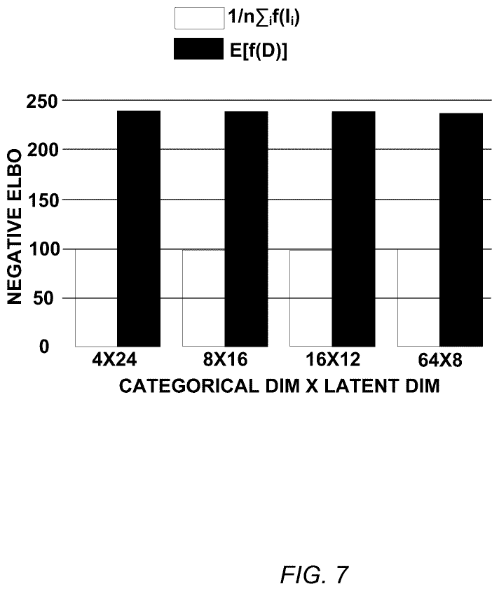

FIG. 7 illustrates, by way of example, a bar graph of negative ELBO for some subtraction baselines and a variety of latent and categorical dimensions. As discussed previously, the choice of subtraction baseline affects the success of ReinMax. Consider

$$\frac{1}{n} {\sum }_{i} f ( {I}_{i} )$$

as the baseline and compare the resulting gradient approximation with ReinMax. As visualized in FIG. 7, ReinMax, which uses E[f(D)] as the baseline, significantly outperforms a version that uses

$$\frac{1}{n} {\sum }_{i} f ( {I}_{i} )$$

as the baseline. The gradient approximation using may be unstable as it contains a

$$\frac{1}{n \cdot p ( D )}$$

term.

On MNIST-VAE (four settings with the 2⁴⁸ latent space), some heatmaps help visualize the final performance of all five methods under different temperatures, e.g., {0.1; 0.3; 0.5; 0.7; 1; 2; 3; 4; 5}. As in FIG. 4, these methods have different preferences for the temperature configuration. Specifically, STGS, GST-1.0, and GR-MCK prefer to set the temperature τ≤1. ST and ReinMax prefer to set the temperature τ≥1. These observations support that a small t can help reduce the bias introduced by STGS-style methods. Also, it verifies that ST and ReinMax work in different ways from STGS, GST-1.0, and GR-MCK.

A simple implementation of ReinMax is provided in the Algorithm 2. It is easy to see that ReinMax has the same order of time complexity and memory complexity as ST and STGS. An empirical comparison on the efficiency is provided.

The average time cost per batch and peak memory consumption on quadratic programming and MNIST-VAE, on an idle A6000 GPU, was measured. Also, to better reflect the efficiency of gradient estimators, all parameter updates were skipped in this experiment. The results are summarized in Table 4. Observe that, as GR-MCK uses the Monte Carlo method to reduce the variance, it has a larger time and memory consumption, which becomes less significant with fewer Monte Carlo samples (GR-MCKₛ can be used to indicate GR-MCK with s Monte Carlo samples). Observe that all remaining methods have roughly the same time and memory consumption. This shows that the computation overheads of ReinMax are negligible.

TABLE 4
Average time cost (per epoch)/peak memory consumption on QP and MNIST-VAE. QP is
configured to have 128 binary latent variables and 512 samples per batch. MNIST-
VAE is configured to have 10 categorical dimensions and 30 latent dimensions.

| | | | | | GR- | GR- | GR- |
|---|---|---|---|---|---|---|---|
| | ReinMax | ST | STGS | GST-1.0 | MCK₁₀₀ | MCK₃₀₀ | MCK₁₀₀₀ |
| QP | 0.2 s/ | 0.2 s/ | 0.2 s/ | 0.2/ | 0.8 s/ | 2.2 s/ | 6.6 S/ |
| | 6.5 Mb | 5.0 Mb | 5.5 Mb | 8.0 Mb | 0.3 Gb | 1 Gb | 3 Gb |
| MNIST- | 5.2 s/ | 5.2 s/ | 5.2 s/ | 5.2 s/ | 5.2 s/ | 5.2 s/ | 5.4 s/ |
| VAE | 13 Mb | 13 Mb | 13 Mb | b13 Mb | 76 Mb | 0.2 Gb | 0.6 Gb |

As discussed, ST works as a first-order approximation of the gradient. ReinMax achieves second-order accuracy without requiring second-order derivatives. Experiments were conducted on polynomial programming, unsupervised generative modeling, and structured output prediction. ReinMax brings consistent improvements over the state-of-the-art.

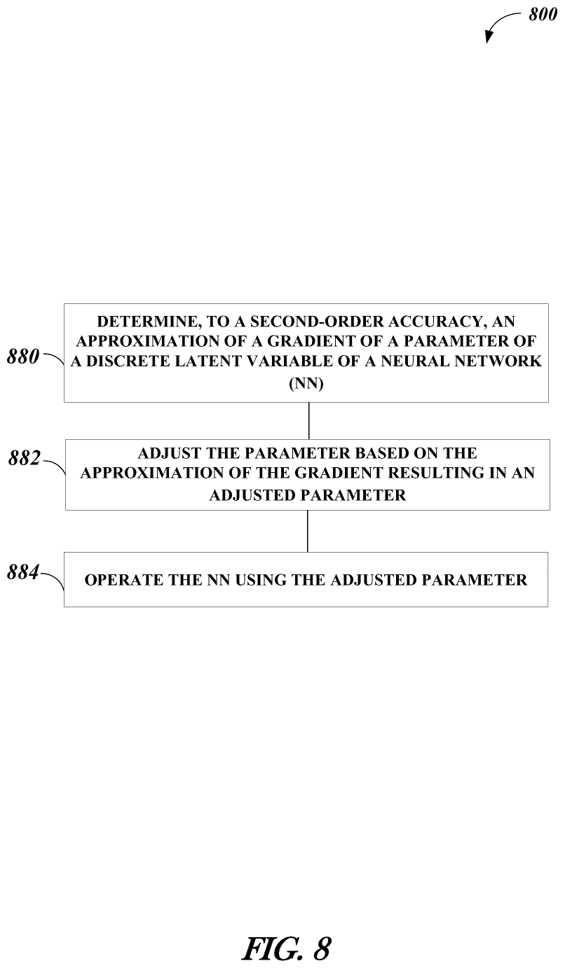

FIG. 8 illustrates, by way of example, a block diagram of an embodiment of a method 800 for backpropagation to a discrete latent variable. The method 800 as illustrated includes determining, to a second-order accuracy, an approximation of a gradient of a parameter of a discrete latent variable of a neural network (NN), at operation 880; adjusting the parameter based on the approximation of the gradient resulting in an adjusted parameter, at operation 882; and operating the NN using the adjusted parameter, at operation 884.

The operation 880 can include sampling a one hot encoding of output of the NN resulting in a sample. The operation 880 can include computing a first algorithmic combination of the sample and a tempered probability distribution of outcomes for the output of the NN. The operation 880 can include determining a second probability distribution of outcomes based on the tempered probability distribution and the output of the NN. The operation 880 can include determining a second algorithmic combination of the probability distribution of outcomes and the second probability distribution of outcomes resulting in a third probability distribution of outcomes. The operation 880 can include altering a value of the sample based on the third probability distribution of outcomes resulting in an altered value. The operation 882 can be based on the altered value.

The operation 880 can include determining a first probability distribution of outcomes based on output of the NN. The operation 880 can include determining, based on the first probability distribution of outcomes, a one hot encoding. The first algorithmic combination can be an average. The second algorithmic combination can be a weighted difference between the probability distribution of outcomes and the second probability distribution of outcomes. A temperature of the tempered probability distribution can be greater than, or equal to, one. The operations of the method can be constrained to a baseline subtraction that is set to an expected value of the sample.

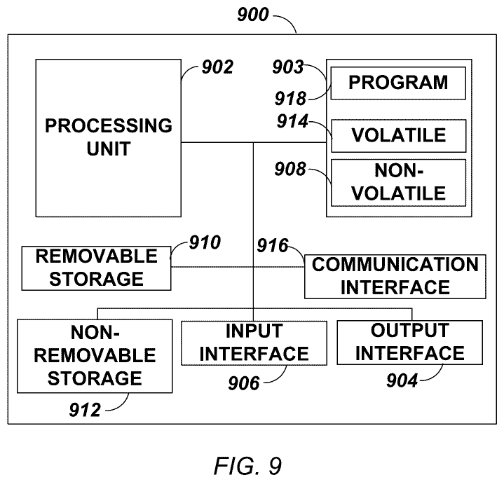

FIG. 9 illustrates, by way of example, a block diagram of an embodiment of a machine 900 (e.g., a computer system) to implement one or more embodiments. The machine 900 can implement ReinMax. Any of the environment of FIG. 1, method 200, method 800 or a component or operation thereof can include one or more of the components of the machine 900. One or more of the environment of FIG. 1, method 200, method 800, or a component or operations thereof can be implemented, at least in part, using a component of the machine 900. One example machine 900 (in the form of a computer), may include a processing unit 902, memory 903, removable storage 910, and non-removable storage 912. Although the example computing device is illustrated and described as machine 900, the computing device may be in different forms in different embodiments. For example, the computing device may instead be a smartphone, a tablet, smartwatch, or other computing device including the same or similar elements as illustrated and described regarding FIG. 9. Devices such as smartphones, tablets, and smartwatches are generally collectively referred to as mobile devices. Further, although the various data storage elements are illustrated as part of the machine 900, the storage may also or alternatively include cloud-based storage accessible via a network, such as the Internet.

Memory 903 may include volatile memory 914 and non-volatile memory 908. The machine 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 900 may include or have access to a computing environment that includes input 906, output 904, and a communication connection 916. Output 904 may include a display device, such as a touchscreen, that also may serve as an input device. The input 906 may include one or more of a touchscreen, touchpad, mouse, keyboard, camera, one or more device-specific buttons, one or more sensors integrated within or coupled via wired or wireless data connections to the machine 900, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 902 (sometimes called processing circuitry) of the machine 900. A hard drive, CD-ROM, and RAM are some examples of articles including a non-transitory computer-readable medium such as a storage device. For example, a computer program 918 may be used to cause processing unit 902 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a method comprising determining, to a second-order accuracy, an approximation of a gradient of a parameter of a discrete latent variable of a neural network (NN), adjusting the parameter based on the approximation of the gradient resulting in an adjusted parameter, and operating the NN using the adjusted parameter.

In Example 2, Example 1 further includes, wherein determining the approximation of the gradient includes sampling a one hot encoding of output of the NN resulting in a sample, computing a first algorithmic combination of the sample and a tempered probability distribution of outcomes for the output of the NN, determining a second probability distribution of outcomes based on the tempered probability distribution and the output of the NN, computing a second algorithmic combination of the probability distribution of outcomes and the second probability distribution of outcomes resulting in a third probability distribution of outcomes, altering a value of the sample based on the third probability distribution of outcomes resulting in an altered value, and wherein adjusting the parameter is based on the altered value.

In Example 3, Example 2 further includes, wherein determining the approximation of the gradient further comprises determining a first probability distribution of outcomes based on output of the NN, and determining, based on the first probability distribution of outcomes, a one hot encoding.

In Example 4, at least one of Examples 2-3 further includes, wherein the first algorithmic combination is an average.

In Example 5, at least one of Examples 2-4 further includes, wherein the second algorithmic combination is a weighted difference between the probability distribution of outcomes and the second probability distribution of outcomes.

In Example 6, at least one of Examples 2-5 further includes, wherein a temperature of the tempered probability distribution is greater than, or equal to, one.

In Example 7, at least one of Examples 2-6 further includes, wherein the operations are constrained to a baseline subtraction that is set to an expected value of the sample.

Example 8 includes a non-transitory machine-readable medium including instructions that, when executed by a machine, cause the machine to perform operations comprising determining, to an accuracy of a second term of a Taylor expansion, an approximation of a gradient of a parameter of a discrete latent variable of a neural network (NN), adjusting the parameter based on the approximation of the gradient resulting in an adjusted parameter, and operating the NN using the adjusted parameter.

In Example 9, Example 8 further includes, wherein determining the approximation of the gradient includes sampling a one hot encoding of output of the NN resulting in a sample, computing a first algorithmic combination of (i) the sample and (ii) a tempered probability distribution of outcomes for the output of the NN, and determining a second probability distribution of outcomes based on (i) the tempered probability distribution and (ii) the output of the NN.

In Example 10, Example 9 further includes, wherein determining the approximation of the gradient includes computing a second algorithmic combination of (i) the probability distribution of outcomes and (ii) the second probability distribution of outcomes resulting in a third probability distribution of outcomes, altering a value of the sample based on the third probability distribution of outcomes resulting in an altered value, and wherein adjusting the parameter is based on the altered value.

In Example 11, Example 10 further includes, wherein determining the approximation of the gradient further comprises determining a first probability distribution of outcomes based on output of the NN, and determining, based on the first probability distribution of outcomes, a one hot encoding.

In Example 12, at least one of Examples 10-11 further includes, wherein determining the approximation of the gradient is performed without determining a Hessian matrix or a second-order derivative.

In Example 13, at least one of Examples 10-12 further includes, wherein the first algorithmic combination is an average.

In Example 14, at least one of Examples 10-13 further includes, wherein the second algorithmic combination is a weighted difference between the probability distribution of outcomes and the second probability distribution of outcomes.

In Example 15, at least one of Examples 10-14 further includes, wherein a temperature of the tempered probability distribution is greater than, or equal to, one.

In Example 16, at least one of Examples 10-15 further includes, wherein the operations are constrained to a baseline subtraction that is set to an expected value of the sample.

Example 17 includes a system comprising a memory storing parameters of a neural network (NN) that includes parameters of discrete latent variables, and processing circuitry configured to determine, to a second-order accuracy, an approximation of a gradient of a parameter of a discrete latent variable of a neural network (NN), adjust the parameter based on the approximation of the gradient resulting in an adjusted parameter, and operate the NN using the adjusted parameter.

In Example 18, Example 17 further includes, wherein determining the approximation of the gradient includes sampling a one hot encoding of output of the NN resulting in a sample, computing a first algorithmic combination of (i) the sample and (ii) a tempered probability distribution of outcomes for the output of the NN, and determining a second probability distribution of outcomes based on (i) the tempered probability distribution and (ii) the output of the NN.

In Example 19, Example 18 further includes, wherein determining the approximation of the gradient includes computing a second algorithmic combination of (i) the probability distribution of outcomes and (ii) the second probability distribution of outcomes resulting in a third probability distribution of outcomes, altering a value of the sample based on the third probability distribution of outcomes resulting in an altered value, and wherein adjusting the parameter is based on the altered value.

In Example 20, Example 19 further includes, wherein determining the approximation of the gradient further comprises determining a first probability distribution of outcomes based on output of the NN, and determining, based on the first probability distribution of outcomes, a one hot encoding.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
determining, to a second-order accuracy, an approximation of a gradient of a parameter of a discrete latent variable of a neural network (NN);
adjusting the parameter based on the approximation of the gradient resulting in an adjusted parameter; and
operating the NN using the adjusted parameter.

2. The method of claim 1, wherein determining the approximation of the gradient includes:
sampling a one hot encoding of output of the NN resulting in a sample;
computing a first combination of the sample and a tempered probability distribution of outcomes for the output of the NN;
computing a second probability distribution of outcomes based on the tempered probability distribution and the output of the NN;
computing a second combination of the probability distribution of outcomes and the second probability distribution of outcomes resulting in a third probability distribution of outcomes;
altering a value of the sample based on the third probability distribution of outcomes resulting in an altered value; and
wherein adjusting the parameter is based on the altered value.

3. The method of claim 2, wherein determining the approximation of the gradient further comprises:
determining a first probability distribution of outcomes based on output of the NN; and
determining, based on the first probability distribution of outcomes, a one hot encoding.

4. The method of claim 2, wherein the first combination is an average.

5. The method of claim 2, wherein the second combination is a weighted difference between the probability distribution of outcomes and the second probability distribution of outcomes.

6. The method of claim 2, wherein a temperature of the tempered probability distribution is greater than, or equal to, one.

7. The method of claim 2, wherein the operations are constrained to a baseline subtraction that is set to an expected value of the sample.

8. A non-transitory machine-readable medium including instructions that, when executed by a machine, cause the machine to perform operations comprising:
determining, to an accuracy of a second term of a Taylor expansion, an approximation of a gradient of a parameter of a discrete latent variable of a neural network (NN);
adjusting the parameter based on the approximation of the gradient resulting in an adjusted parameter; and
operating the NN using the adjusted parameter.

9. The non-transitory machine-readable medium of claim 8, wherein determining the approximation of the gradient includes:
sampling a one hot encoding of output of the NN resulting in a sample;
computing a first combination of (i) the sample and (ii) a tempered probability distribution of outcomes for the output of the NN; and
computing a second probability distribution of outcomes based on (i) the tempered probability distribution and (ii) the output of the NN.

10. The non-transitory machine-readable medium of claim 9, wherein determining the approximation of the gradient includes:
computing a second combination of (i) the probability distribution of outcomes and (ii) the second probability distribution of outcomes resulting in a third probability distribution of outcomes;
altering a value of the sample based on the third probability distribution of outcomes resulting in an altered value; and
wherein adjusting the parameter is based on the altered value.

11. The non-transitory machine-readable medium of claim 10, wherein determining the approximation of the gradient further comprises:
determining a first probability distribution of outcomes based on output of the NN; and
determining, based on the first probability distribution of outcomes, a one hot encoding.

12. The non-transitory machine-readable medium of claim 10, wherein determining the approximation of the gradient is performed without determining a Hessian matrix or a second-order derivative.

13. The non-transitory machine-readable medium of claim 10, wherein the first combination is an average.

14. The non-transitory machine-readable medium of claim 10, wherein the second combination is a weighted difference between the probability distribution of outcomes and the second probability distribution of outcomes.

15. The non-transitory machine-readable medium of claim 10, wherein a temperature of the tempered probability distribution is greater than, or equal to, one.

16. The non-transitory machine-readable medium of claim 10, wherein the operations are constrained to a baseline subtraction that is set to an expected value of the sample.

17. A system comprising:
a memory storing parameters of a neural network (NN) that includes parameters of discrete latent variables; and
processing circuitry configured to:
determine, to a second-order accuracy, an approximation of a gradient of a parameter of a discrete latent variable of a neural network (NN);
adjust the parameter based on the approximation of the gradient resulting in an adjusted parameter; and
operate the NN using the adjusted parameter.

18. The system of claim 17, wherein determining the approximation of the gradient includes:
sampling a one hot encoding of output of the NN resulting in a sample;
computing a first combination of (i) the sample and (ii) a tempered probability distribution of outcomes for the output of the NN; and
determining a second probability distribution of outcomes based on (i) the tempered probability distribution and (ii) the output of the NN.

19. The system of claim 18, wherein determining the approximation of the gradient includes:
computing a second combination of (i) the probability distribution of outcomes and (ii) the second probability distribution of outcomes resulting in a third probability distribution of outcomes;
altering a value of the sample based on the third probability distribution of outcomes resulting in an altered value; and
wherein adjusting the parameter is based on the altered value.

20. The system of claim 19, wherein determining the approximation of the gradient further comprises:
determining a first probability distribution of outcomes based on output of the NN; and
determining, based on the first probability distribution of outcomes, a one hot encoding.
